(19) United States
(12) Patent Application Publication
(10) Pub. No.: US 2024/0410202 A1
(43) Pub. Date: Dec. 12, 2024

(54) Locking Mechanism For Vehicle Having External Storage Compartments

(71) Applicant: Andina Foster, Beaufort, SC (US)

(72) Inventor: Andina Foster, Beaufort, SC (US)

(21) Appl. No.: 18/207,398

(22) Filed: Jun. 8, 2023

(51) Int. Cl. E05B 77/50; B60R 25/01; E05B 81/10; E05B 83/22

(52) U.S. Cl. CPC E05B 77/50; B60R 25/01; E05B 81/10; E05B 83/22

(57) ABSTRACT

A manually operated master pneumatic piston is connected to up to a number of slave pneumatic bolts through a master-slave connector tubing element. The slave pneumatic bolts are activated simultaneously when the master pneumatic piston is activated, locking storage receptacles, such as storage compartments on a recreational vehicle.

### TECHNICAL FIELD

The disclosure, in general, relates to a locking mechanisms for compartments and, more particularly, but without limitation, is directed to a manually operated pneumatic piston locking system for storage compartments.

### BACKGROUND

Certain buses (e.g., at airports, or long-distance passenger transport) have exterior compartments for storing passenger luggage and other items. Various utility trucks have exterior storage compartments for storing tools. (See, e.g., U.S. Pat. No. 2,616,754 to Stahl and 4,917,430 to Lawrence.) U.S. Pat. No. 1,632,360 to Wilson, for an armored truck for transporting valuables (e.g., currency, jewelry, etc. between banks or to jewelry stores, post offices), discloses a truck in which a truck body and cab are constructed of suitable armor plate, to make the truck bullet-proof. The '360 patent also discloses a locking mechanism that enables a driver in the truck cab to instantly lock all the doors and windows in the cab of the truck to protect himself from outside attack. However, the '360 patent further discloses that the external storage compartments used to store valuables are locked and unlocked separately.

U.S. Pat. No. 4,892,345 to Rachael, Ill discloses an armored vehicle with an attached vault section having separate cargo compartments, with each cargo compartment having a door independently controlled for unlocking and opening purposes. The '345 patent also discloses a locking mechanism designed to lock and unlock the separate cargo compartments sequentially.

Recreational Vehicles (RVs) have many externally accessible storage lockers and drawers, each having a locking mechanism of some sort. For RVs, the externally accessible storage areas will be keyed alike, for enabling an RV user to lock/unlock using only one key. Walking to each storage area for unlocking or locking purposes is tedious. Checking to confirm all storage areas have been locked, e.g., when leaving an RV unguarded is also time consuming. RVs often have a generic key that will fit other RVs, especially the same brand. Individual or group-keyed lock replacements are expensive

Therefore, a need exists for an inexpensive locking system to address locking multiple compartments with a single master device.

### SUMMARY

A manually operated master pneumatic piston is connected to up to a number of slave pneumatic bolts through a master-slave connector tubing element. The slave pneumatic bolts are activated simultaneously when the master pneumatic piston is activated, locking or unlocking storage receptacles, such as storage compartments on a recreational vehicle.

In an aspect of the disclosure, a locking mechanism for a vehicle comprising one or more storage receptacles is disclosed. The locking mechanism includes a manually-operated master pneumatic piston; one or more pneumatically-operated slave bolts, where the one or more pneumatically-operated slave bolts are operably connected to the manually-operated master pneumatic piston through a master-slave connector element, and when the manually-operated master pneumatic piston is actuated, the one or more pneumatically-operated slave bolts are simultaneously actuated to lock or unlock the one or more storage receptacles.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a recreational vehicle.

FIG. 2 is a schematic view of a locking mechanism for a vehicle, according to an aspect of the disclosure.

### DETAILED DESCRIPTION

The following briefly describes the aspects of the disclosure in order to provide a basic understanding of some aspects of the disclosure. This brief description is not intended as an extensive overview. It is not intended to identify key or critical elements, or to delineate or otherwise narrow the scope. Its purpose is merely to present some concepts in a simplified form as a prelude to the more detailed description that is presented later.

The disclosure is directed to a locking mechanism for a bus, a utility vehicle, or another vehicle, including a recreational vehicle (RV), having one or more externally accessible hatch doors or panels used for securing tools, luggage, or other personal articles in vehicle storage areas. The mechanism locks and unlocks all storage areas virtually simultaneously.

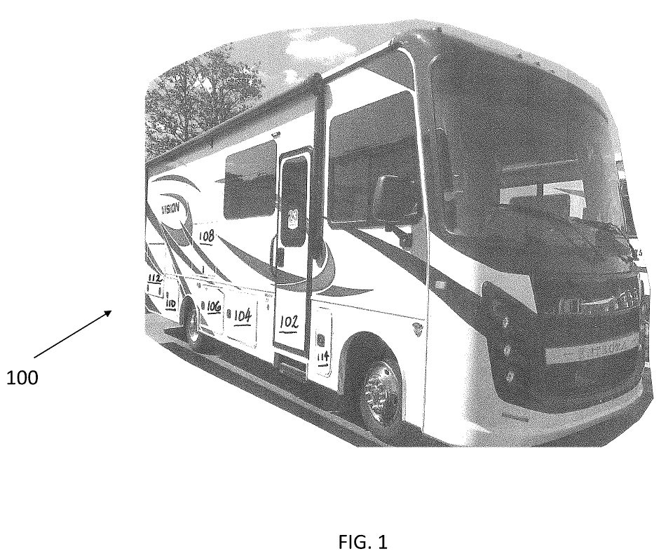

Referring initially to FIG. 1, a recreational vehicle (RV) 100 including-as externally accessible doors, panels, or covers-an entrance door 102, two storage area panels or covers 104 and 106, a panel or cover 108 for a pull-out TV screen-and-entertainment unit (not shown). another storage area panel or cover 110, a panel or cover 112 for a pull-out cooking-and-kitchen unit (not shown), and a panel or cover 114 for an outwardly extendable and inwardly retractable utility (e.g., electrical power, natural gas, pressurized potable water) services connection (located closely adjacent the entrance door 102) are shown to demonstrate principles of the disclosure.

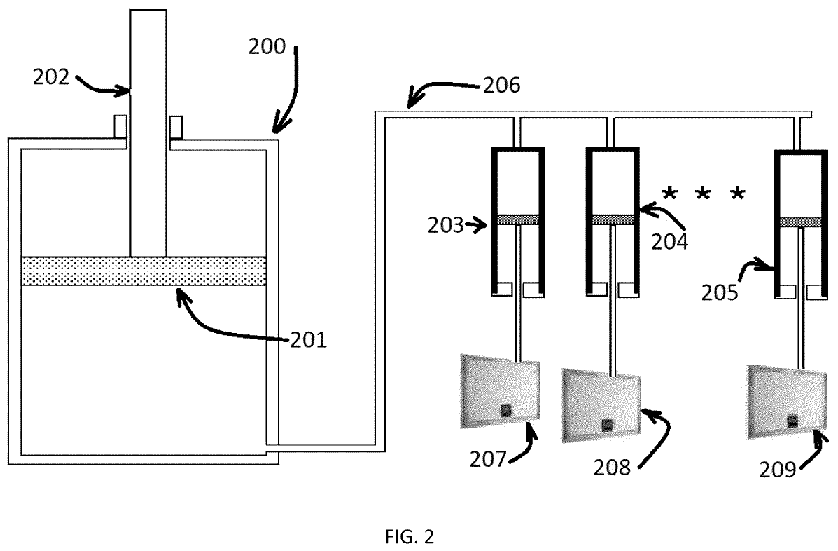

FIG. 2 is a schematic view of a locking mechanism 200 for a vehicle, such as an RV 100 Other vehicle types are possible. The locking mechanism 200 includes a master pneumatic piston. such as a manually-operated master pneumatic piston 201. The manually-operated master pneumatic piston 201 may include a piston rod 202 to activate the manually-operated master pneumatic piston 201 Other actuation elements may be contemplated by one of ordinary skill in the art. The locking mechanism 200 may include one or more pneumatically-operated slave bolts (203-205). FIG. 2 illustrates 3 exemplary pneumatically-operated slave bolts (203-305), however the number of pneumatically-operated slave bolts (203-205) may include a larger or smaller number of pneumatically-operated slave bolts (203-205) depending on the application and physical parameters and limitations of the locking mechanism. In an aspect, the one or more pneumatically-operated slave bolts (203-205) are operably connected to the manually-operated master pneumatic piston 201 through a master-slave connector element 206 to create a pneumatically closed system.

In an aspect, the master-slave connector element 206 may include tubing between the one or more pneumatically-operated slave bolts (203-205) and the manually-operated master pneumatic piston 201. In an aspect, tubing may be rubber or plastic tubing. Other materials may be substituted without deviating from the scope of the disclosure.

In an aspect, the displacement of the manually-operated master pneumatic piston 201 must exceed three or more times the total volumetric capacity of each of the one or more pneumatically-operated slave bolts (203-205) slave so that a full master piston stroke delivers sufficient air to operate up to “N” pneumatically-operated slave bolts (203-205). One of skill in the art would understand to modify the design to function as described without deviating from the scope of the disclosure. In an aspect of the closed pneumatic system, a manually operated valve may be used to add or remove air

In an aspect, when the manually-operated master pneumatic piston 201 is actuated, the one or more pneumatically-operated slave bolts (203-205) are simultaneously actuated to lock or unlock one or more storage receptacles (207-209). In an aspect, the one or more pneumatically-operated slave bolts (203-205) may be rendered inoperative by associated shut off valves in the tubing 206.

In an aspect, the one or more pneumatically-operated slave bolts (203-205) may extend, during activation, to secure the one or more storage receptacles (207-209)

In an aspect, the one or more storage receptacles (207-209) may include one or more external storage receptables disposed upon a recreational vehicle 100. Other storage receptables, compartments and vehicle types may be substituted without deviating from the scope of the disclosure.

It is to be understood that the disclosure encompasses within its scope an implementation of an article of manufacturing for a vehicle locking mechanism for lockable enclosures. The article of manufacturing includes a master pneumatic piston; one or more pneumatic slave bolts, where the one or more pneumatic slave bolts are in communication with the manually-operated master pneumatic piston through a tubing element, and when the master pneumatic piston is actuated, the one or more pneumatic slave bolts are actuated to lock or unlock one or more storage receptacles in communication with the one or more pneumatic slave bolts.

The article of manufacturing may be produced with techniques known to one of skill in the art to manufacture or fabricate by known or conventionally understood techniques, embodying the components disclosed herein to enable a locking mechanism for a vehicle with lockable enclosures.

It is understood that one of ordinary skill in the art may substitute a power driven master cylinder to operate the locking mechanism. In an aspect, the locking mechanism may also be controlled with a radio remote or other wireless device. Those approaches may be used but may lead to additional expenses to implement. Likewise, one of ordinary skill in the art may understand that the use of “pneumatic” cylinders may include using hydraulic cylinders employing a non-compressible liquid.

Although the simplified schematic disclosure presented herein uses only a single tube employing both pressure and suction to eject and retract the bolts, a traditional approach not using suction would require two tubes for each bolt to achieve the same bi-directional functionality using just pressure. The disclosure use of suction actuation is a non-conventional and novel feature that reduces plumbing materials and cost by 50%.

While various aspects of the disclosure have been described, it will be apparent to those of ordinary skill in the art that many more aspects and implementations are possible within the scope of the disclosure. Accordingly, the disclosure is not to be restricted except in light of the attached claims and their equivalents.

What is claimed is:

1. A locking mechanism for a vehicle comprising one or more storage receptacles, comprising:
a manually-operated master pneumatic piston;
one or more pneumatically-operated slave bolts, where the one or more pneumatically-operated slave bolts are operably connected to the manually-operated master pneumatic piston through a master-slave connector element, and when the manually-operated master pneumatic piston is actuated, the one or more pneumatically-operated slave bolts are simultaneously actuated to lock or unlock the one or more storage receptacles.

2. The locking mechanism of claim 1, where the master-slave connector element comprises tubing between the one or more pneumatically-operated slave bolts and the manually-operated master pneumatic piston.

3. An article of manufacture comprising:
a master pneumatic piston;
one or more pneumatic slave bolts, where the one or more pneumatic slave bolts are in communication with the manually-operated master pneumatic piston through a tubing element, and when the master pneumatic piston is actuated, the one or more pneumatic slave bolts are actuated to lock or unlock one or more storage receptacles in communication with the one or more pneumatic slave bolts.

4. The article of manufacture of claim 3, where the tubing element comprises a flexible tubing element.

5. The article of manufacture of claim 3, where the one or more pneumatic slave bolts are simultaneously actuated to lock or unlock one or more storage receptacles.

6. The article of manufacture of claim 3, where the one or more storage receptacles comprise one or more external storage receptables disposed upon a recreational vehicle.
